(19) United States
(12) Patent Application Publication
(10) Pub. No.: US 2002/0143650 A1
(43) Pub. Date: Oct. 3, 2002

(54) Ordering method and system

(75) Inventor: Shuichi Matsuda, Tokyo (JP)

Correspondence Address: McDermott, Will & Emery, 600 13th Street, N.W,, Washington, DC, 20005-3096, US

(73) Assignee: Mitsubishi Denki Kabushiki Kaisha

(21) Appl. No.: 09/970,889

(22) Filed: Oct. 5, 2001

(30) Foreign Application Priority Data
Mar. 27, 2001 (JP) 2001-090659

(51) Int. Cl. G06F 17/60

(52) U.S. Cl. 705/26

(57) ABSTRACT

A network system of a client (semiconductor device manufacturer) and a network system of a product provider (mask manufacturer) are interconnected by means of a private line. A client stores order information in an information management server managed thereby and makes the order information open to the product provider. The product provider accesses the information management server of the client and acquires the order information, thus receiving an order.

### BACKGROUND OF THE INVENTION

1. Field of the Invention

The present invention relates to an ordering method and system utilizing a network. More specifically, the present invention relates to an ordering method and system suitable for a business arrangement in which a client is actively involved in determining specifications of a product; e.g., in the case of transaction of custom-made products.

2. Background Art

Recently, more and more systems receive orders or inquiries pertaining to products or services without involvement of manpower, by utilization of a computer network. More specifically, a provider which provides products or services has a server system for receiving orders and a database for managing various kinds of information items. A client places an order for products with the provider or makes an inquiry about a delivery time or other inquiries by means of accessing the server system.

For instance, Japanese Patent Application Laid-Open No. 269293/1998 describes a workflow management method and system which enable a steel manufacturer to receive a round of orders. Since steel products are custom-made, numerous information items pertaining to product specifications are exchanged between a client and a steel manufacturer at the time of receipt of an order. According to the method and system described in the Laid-Open Patent Application, an outside server for opening information to the public or clients is connected to an internal server via a firewall. Information stored in the outside server is updated so as to become identical with the information accumulated in the internal server, thereby enabling quick and accurate transfer of information to clients. Further, in order to prevent leakage of classified information, persons accessing the outside server are identified, thereby limiting access to predetermined information in accordance with a result of identification.

According to the related-art method, a product provider constitutes a server system and a database. Kinds of information items which can be transmitted to the product provider from clients are dependent on an order form offered from the product provider. Hence, not all information items of which a client desires to inform the product provider are necessarily transmitted to the product provider.

This problem will be described by taking as an example a case where a semiconductor device manufacturer out sources to a mask manufacturer. A photomask is employed in the process of manufacturing a semiconductor device for transferring an interconnection pattern onto a semiconductor substrate. Specifications of a photomask are dependent on specifications of a semiconductor device to be manufactured through use of the photomask. For this reason, in order for a semiconductor device manufacturer to place an order for a photomask with an outside mask manufacturer, the semiconductor device manufacturer must inform the photomask manufacturer of detailed information about mask specifications. In such a transaction, in many cases the semiconductor manufacturer takes the initiative in determining a delivery time and quality. At the time of placing an order, the semiconductor device manufacturer must inform the photomask manufacturer of information about a desired delivery time and quality. Further, in order to make transaction smooth, the semiconductor device manufacturer often informs the photomask manufacturer of information about a plan for developing a semiconductor product.

In this way, in a case where a client provides a product provider with a large volume of information or where contents of the information are sophisticated or complicated, a sufficient volume of information cannot be transferred to the product provider by means of the related-art method, which entitles the product provider to manage the server system and the database. For this reason, information has still been transferred to the product provider by way of a sales representative in charge by means of telephone, facsimile, and meetings. Needless to say, transfer of information with involvement of manpower involves various problems; for example, consumption of a large amount of time and difficulty in responding to sudden changes in specifications or an interrupt request.

### SUMMARY OF THE INVENTION

The present invention has been conceived to solve such problems and provides an ordering method and system which enable a client to freely and actively send information required for transaction to a product provider without involvement of manpower and without being limited by an order form prepared so as to suit the convenience of the product provider.

A client has an information management server which accumulates and manages order information. The information management server is connected to a computer of a product or service provider, and the order information is open to the provider. The provider accesses the information management server of the client and acquires the order information, thus receiving an order.

Other and further objects, features and advantages of the invention will appear more fully from the following description.

### BRIEF DESCRIPTION OF DRAWINGS

The present invention will be more apparent from the following detailed description, when taken in conjunction with the accompanying drawings, in which;

FIG. 1 is a schematic diagram showing the relationship between a semiconductor device manufacturer (client) and a mask manufacturer (provider);

FIG. 2 is an illustration showing the configuration of the ordering system according to the first embodiment of the present invention;

FIG. 3 is a flowchart showing an ordering process according to the first embodiment;

FIG. 4 is a flowchart showing a process of giving information from the provider to client according to the first embodiment.

FIG. 5 is a flowchart showing a ordering process according to the second embodiment; and

FIG. 6 is a flowchart showing a process of giving information from the provider to client according to the second embodiment.

### DETAILED DESCRIPTION OF THE PREFERRED EMBODIMENTS

Preferred embodiments of the present invention will be described by reference to the accompanying drawings. Any one of ordering systems, which will be described below, corresponds to an ordering system to be used in a case where transaction of photomasks is carried out between a semiconductor device manufacturer (client) and a mask manufacturer (product provider).

First Embodiment

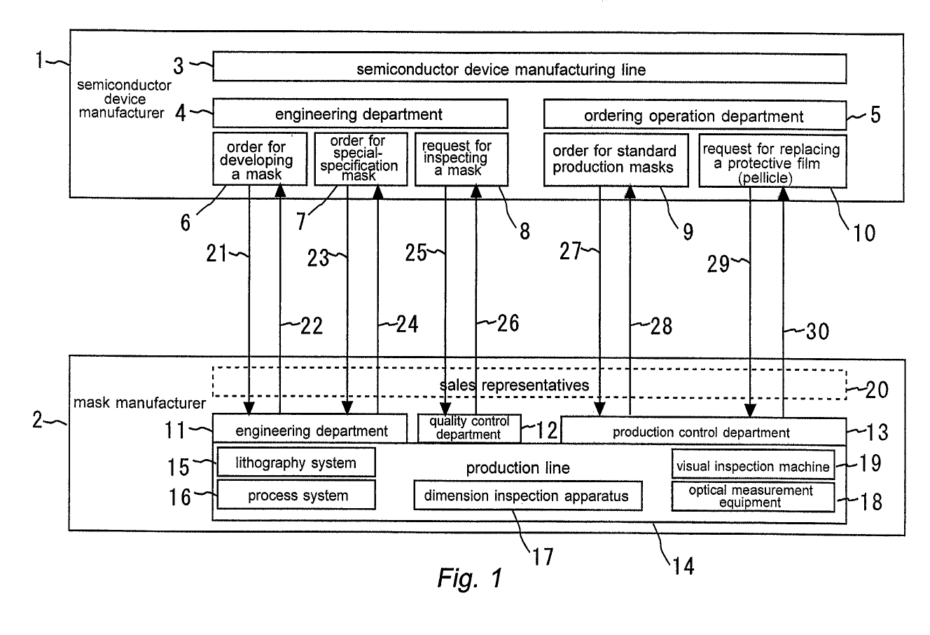

FIG. 1 is a schematic diagram showing the relationship between a semiconductor device manufacturer 1 and a mask manufacturer 2. The semiconductor device manufacturer 1 comprises a semiconductor device manufacturing line 3, an engineering department 4, and an ordering operation department 5. An order for a photomask required for manufacturing semiconductor devices in the semiconductor manufacturing line 3 is placed with the mask manufacturer 2 by the engineering department 4 or the ordering operation department 5. The engineering department 4 is responsible for developing new products, designing products complying with special specifications, and tracking down any problems that have arisen in the semiconductor manufacturing line 3. In association with these business operations, the engineering department 4 places, with the mask manufacturer 2, an order for developing a mask 6 (simply called a “development mask”), an order for a mask 7 for special specifications (simply called a “special-specification mask”), and a request 8 for inspecting a mask. The ordering operation department 5 is responsible for routine work, such as replenishment of normal stock items, placing an order 9 for standard production masks, and issuing a request 10 for replacing a protective film (pellicle) of a mask with another film.

The mask manufacturer 2 comprises an engineering department 11, a quality control department 12, a production control department 13, and a mask production line 14. The engineering department 11 designs details of a mask. The quality control department 12 inspects masks produced in the mask production line 14 and masks which induced problems after having been delivered to a client. The production control department 13 controls production of mass-produced products. Installed in the production line 14 are various types of equipment; that is, a lithography system 15 for drawing a pattern on a mask substrate; a process system 16 for producing a pattern; a dimension inspection apparatus 17 for verifying the dimensions of the formed pattern; optical measurement equipment 18 for inspecting a photomask by means of actually radiating light on a photomask; and a visual inspection machine 19 for verifying anomalies in the appearance of the photomask.

For example, the engineering department 4 of the semiconductor device manufacturer 1 informs the engineering department 11 of the mask manufacturer 2 of information 21, such as order information about the development mask 6 required for prototyping a semiconductor product under development, a desired delivery time, mask specifications, and a future development plan. In response to the information 21, the mask manufacturer 2 returns, in reply to the semiconductor device manufacturer 1, information 22 such as progress in manufacture of a mask, the status of a mask in process, and the shipment status and delivery time of mask products. Similarly, information is exchanged between the semiconductor device manufacturer 1 and the mask manufacturer 2, as designated by 23 and 24, in relation to the special-specification mask 7.

Information 25 about an inspection request or about inquiries pertaining to mask quality is transmitted to the quality control department 12 of the mask manufacturer 2 from the engineering department 4 of the semiconductor device manufacturer 1. In reply, the quality control department 12 of the mask manufacturer 2 returns, to the engineering department 4 of the semiconductor device manufacturer 1, information 26 such as data pertaining to a report on quality of mask products or inquiries about quality.

The ordering operation department 5 of the semiconductor device manufacturer 1 sends to the production control department 13 of the mask manufacturer 2 ordering information 27 pertaining to the standard production masks 9 and a request 29 for replacing a protective film (pellicle) of the photomask with another film. In response to the ordering information 27 or the request 29, the production control department 13 of the mask manufacturer 2 returns, to the ordering operation department 5 of the semiconductor manufacturer 1, information 28 and 30 pertaining to progress in replacement of an pellicle, the status of the replacement operation in progress, and the status of delivery and a delivery time.

In addition, various kinds of information items, such as engineering information about manufacture of a mask and maintenance information pertaining to various types of equipment 15, 16, 17, 18 and 19 constituting the mask production line 14, are exchanged between the semiconductor device manufacturer 1 and the mask manufacturer 2. The information items are usually exchanged byway of sales representatives 20. However, exchange of information items with involvement of manpower involves problems, such as a delay in transmission of information or inaccuracy of information transmitted. Hence, the following ordering system enables transmission of the above-described information items without involvement of manpower.

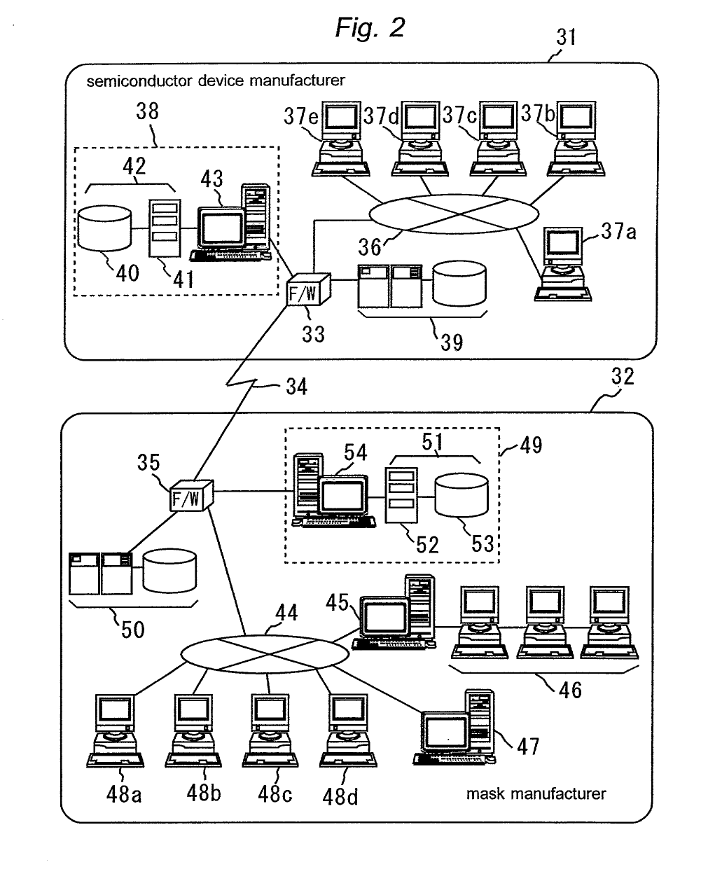

FIG. 2 is an illustration showing the configuration of the ordering system according to the first embodiment of the present invention. As illustrated, the ordering system is a network system. More specifically, the network system is constituted by means of connecting an intraoffice network system 31 of the semiconductor manufacturer 1 with an intraoffice network system 32 provided in the mask manufacturer 2 by way of security control devices (hereinafter called“firewalls” (F/W)) 33 and 35, through use of a high-speed private line 34 embodied as, for example, an optical fiber. In the present embodiment, the private line 34 is employed for reasons of superiority in data transfer rate and security of information. However, this does not mean that the intraoffice network systems 31 and 32 must be interconnected by way of a private line, and they may alternatively be interconnected by way of a dial-up line or the Internet.

The system 31 of the semiconductor device manufacturer 1 is constituted of a local area network 36 (hereinafter called a “LAN”); terminals 37 which are provided in individual departments in the company and connected to the LAN 36; an information management server 38 for controlling information to be exchanged with the mask manufacturer 1; and a data control server 39 for controlling other information items. The terminals 37 disposed in the individual departments correspond to information processing apparatus, such as personal computers or workstations. A program for implementing functions to be described later is installed in each of the terminals 37. The information management server 38 is constituted of a database server 42 and a WEB server 43. Here, the database server 42 comprises a database 40 constituted in a storage device, and a computer 41, wherein the storage device has been duplexed for ensuring reliability. Further, database control software is incorporated in the computer 41.

The system 32 of the mask manufacturer 2 comprises a LAN 44; a production control server 45 connected to the LAN 44; a quality control server 47; terminals 48 provided in individual departments; an information management server 49 for controlling information to be exchanged with the semiconductor device manufacturer 1; and a data control server 50 for controlling other information items. The production control server 45 collectively manages progress information entered from the production line, through use of a computer connected to a plurality of terminals 46managedby individual workgroups in the production line of a factory. The quality control server 47 summarizes and manages results of inspection of mask products performed in the production line. The production control server 45, the quality control server 47, and the terminals 48 disposed in individual departments are embodied in information processing apparatus such as personal computers or workstations. A program for implementing functions to be described later is installed in each of the pieces of information processing apparatus. The information management server 49 comprises a database server 51, which includes a database constituted on a storage device duplicated for ensuring reliability and a computer 52 having database control software incorporated therein, and a WEB server 54 which receives access from each of the terminals 48 and has incorporated therein a program controlling access.

The greatest contrast between the conventional ordering system and the ordering system according to the present invention lies in that the semiconductor device manufacturer has the information management server 38 for accumulating information to be provided for the mask manufacturer 2. This does not mean that the information management server 38 of the semiconductor device manufacturer must be included in the intraoffice network 31 of the semiconductor device manufacturer 1. More specifically, no limitation is imposed on the location where the information management server is installed. Moreover, the difference does not mean that the semiconductor device manufacturer 1 must have exclusive ownership of a computer to be used as an information management server; a rental computer or a computer shared between several users may be used. In an extreme case, a computer may be shared between the semiconductor device manufacturer 1 and the mask manufacturer 2. The “information management server 38 of the semiconductor device manufacturer 1” signifies that the semiconductor device manufacturer 1 is entitled to free use of a server computer and that the server computer can freely open ordering information or other information items to the public or manage and accumulate these information items.

Procedures for exchange various types of information items, such as ordering information items, will be described hereinbelow. To begin with, information provided from the semiconductor device manufacturer 1 to the mask manufacturer 2 will be described. Responsible staff members in the respective departments of the semiconductor device manufacturer 1 enter, on a monthly basis, the kinds and quantity of masks desired to be ordered in the next month, by way of the terminals 37 disposed in the respective departments. The thus-entered data are transferred to a terminal 37a of the ordering operation department 5 by way of the LAN 36, where a summarizer program installed in the terminal 37a summarizes the data. The terminal 37a of the ordering operation department 5 prepares an order statement by adding information about a desired delivery time to the summarized data. The thus-prepared order statement is transferred to the information management server 38 by way of the LAN 36 and registered in the database 40. In addition to the order statement, mask designers and semiconductor device designers in the engineering department prepare information items, such as mask specifications, development plans, FAQs (frequently asked questions), and answers to FAQs. The information items are transferred to the information management server 38 by way of the LAN 36 and registered in the database 40. The semiconductor device manufacturer 1 can freely determine a format of information items. Hence, a mask specification can be registered as image data representing a mask layout, and a development plan can be registered as presentation data with voice data.

The WEB server 43 receives intraoffice access and outside access and provides information managed by the database 42. An order for a mask is completed by sales representatives of the mask manufacturer 2 accessing the information management server 38 consisting of the WEB server 43 and the database 42 and browsing and downloading information about an order statement or a mask specification stored in the database 40. Further, responsible engineers in the mask manufacturer 2 access the information management server 38 of the semiconductor device manufacturer 1, thus acquiring information about a development plan of a semiconductor device and FAQs registered in the database 40.

The range of information which employees of the mask manufacturer 2 can access and acquire on the information control server 38 of the semiconductor device manufacturer 1 changes according to access rights of the employees (hereinafter called “security levels”) . For example, if a staff member other than the responsible business representative can freely download an order statement, a problem may arise in business transaction. In the ordering system according to the present embodiment, a security level is checked not by the semiconductor device manufacturer 1 but by the information management server 49 of the mask manufacturer 2. The reason for this is that management of security levels of all employees or terminals of the mask manufacturer 2 by the semiconductor device manufacturer 1 imposes inconvenience to the semiconductor device manufacturer 1. If no particular inconvenience arises, the information management server 38 of the semiconductor device manufacturer 1 accessed by the employees of the mask manufacturer 2 may check the security levels of the employees or terminals of the mask manufacturer 2.

In the ordering system, limitations imposed on an access according to the security level are implemented by the firewall 35 and an access limitation program installed in the information management server 49 of the mask manufacturer 1. By means of settings of the firewall 35, employees of the mask manufacturer 2 are prohibited from directly accessing the information management server 38 of the semiconductor device manufacturer 1 by way of the terminals 48 disposed in the respective departments. Next, the employees of the mask manufacturer 2 are enabled to access the information management server 38 of the semiconductor device manufacturer 1 by means of accessing the information management server 49 of the mask manufacturer 2. The security level of a person who has made access by means of the program installed in the information management server 49 of the mask manufacturer 2 is checked, and a link list corresponding to the security level is displayed, along with a link list corresponding to the security level. Consequently, the employee of the mask manufacturer 2 can access the information managed by the information management server 38 of the semiconductor device manufacturer 1 within only the range defined by the displayed link list.

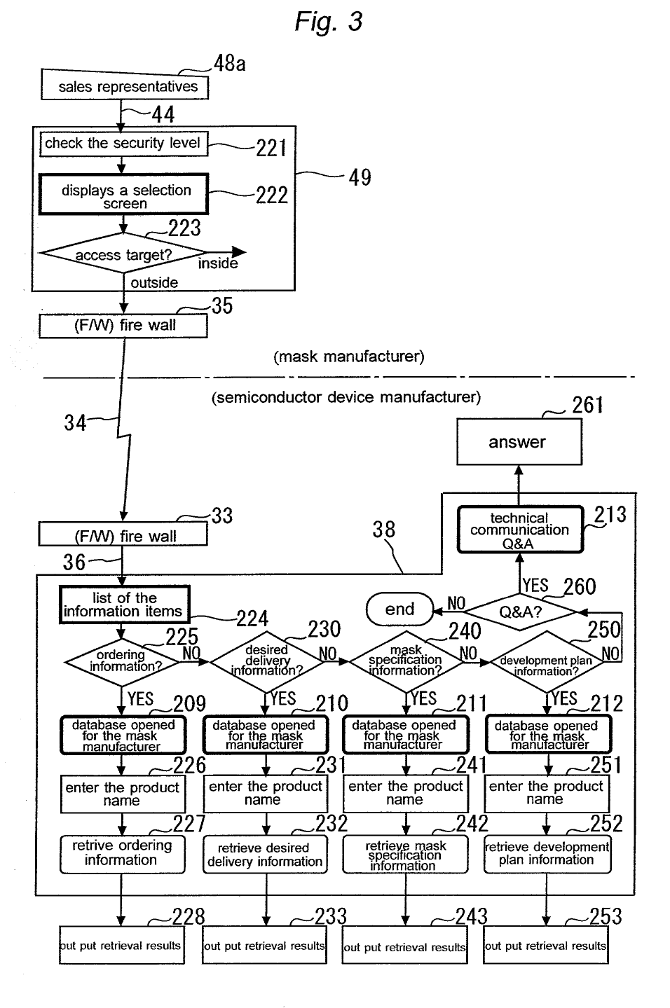

FIG. 3 is a flowchart showing the process described above. When a responsible business representative of the mask manufacture 2 has accessed the information management server 49 from a terminal 48a by way of the LAN 44, the information management server 49 checks the security level of the business representative (221). Subsequently, the information management server 49 displays a selection screen pertaining to targets of access (222). If the semiconductor device manufacture 1 outside the mask manufacturer 2 has been selected as an access target (223), there is displayed a link list pertaining to the information managed by the information management server 38 of the semiconductor device manufacturer 1. As mentioned previously, the displayed link list varies according to a security level of the person who has attempted to make access.

Five items; that is, “ordering information,” “desired delivery time information,” “mask specification information,” “development plan information,” and “Q&A information,” are displayed as link lists pertaining to information items on a screen of the terminal 48a of a responsible business representative of the mask manufacturer 2 (224). For example, when “ordering information” has been selected (225), the database server 42 of the information management server 38 selects a database opened for the mask manufacture 2 (209). A retrieval screen for enabling entry of a product name appears (226), and ordering information pertaining to an input product is retrieved (227). Retrieval results are output as a list on the screen (228). The information can be downloaded or output to a printer, as required. Even when anyone of items; that is, “desired delivery information” (230), “mask specification information” (240), and “development plan information” (250), has been selected, the similar processing is performed (210, 231, 232, 211, 241, 242, 212, 251, and 252), and corresponding information appears on the screen (233, 243, and 253). When “Q&A information” has been selected (260), technical communication Q&A information (213) appears. The information is a collection of, e.g., frequently asked questions and answers, and a required answer can be retrieved and output (261). Further, an E-mail address assigned to a responsible person in the ordering operation department of the semiconductor device manufacturer 1 is also displayed. So long as a responsible business representative sends an inquiry mail to the thus-displayed mail address, an answer can be offered from the semiconductor device manufacture at a later date.

Turning again to FIG. 1, provision of information from the mask manufacturer 2 to the semiconductor device manufacturer 1 will be described. In a production line of the mask manufacturer, information about completion of an operation and mask quality is entered by way of the corresponding terminal upon completion of any process, such as a lithography process, a mask preparation process, or a dimensional inspection process. From among information items, information representing progress, such as a date at which processing of a process has been completed, is collected by the production control server 45. Information representing quality is collected by the quality control server 47. The production control server 45 summarizes the collected information, thereby preparing production control information to be opened to the semiconductor device manufacturer 1. The quality control server 47 summarizes collected information, thereby preparing quality control information to be opened to the semiconductor device manufacture 1. The thus-prepared production control information and quality control information are transferred to the information management server 49 of the mask manufacturer 2 by way of the LAN 44 and registered in the database 53. Summarizing of information performed by each of the production control server 45 and the quality control server 47 and updating of the database 53 are performed in real time every time new production control information or new quality control information arises. Alternatively, in order to diminish a load imposed on the server and the network, summarizing and updating operations may be performed periodically at a time interval of one-half hour or one hour. As a result, new information can be provided at all times to the semiconductor device manufacturer 1 who is a client.

Upon receipt of intraoffice access or access from the outside, the WEB server 54 provides information managed by the database server 51. Inquiries about progress and a delivery time are effected by means of a staff member responsible for ordering of the semiconductor device manufacturer 1. In the inquiries, the staff member accesses the information management server 49 which consists of the WEB server 54 and the database server 51 and is provided in the mask manufacturer 2, to thereby download or browse information about progress, information about a delivery time and shipment, quality information, information about management of facilities, and other information items.

The range of information which can be acquired by accessing the information management server 49 of the mask manufacture 2 varies according to a security level assigned to each of employees. If every employee can freely browse information, a problem may arise in business transaction. In the ordering system according to the present embodiment, a security level is checked not by the information management server 49 of the mask manufacturer 2 but by the information management server 38 of the semiconductor device manufacturer 1. Needless to say, security check may be performed by the mask manufacturer 1. Access may be limited in the same manner as in the case where the responsible business representative of the mask manufacturer 2 accesses the information management server 38 of the semiconductor device manufacturer 1.

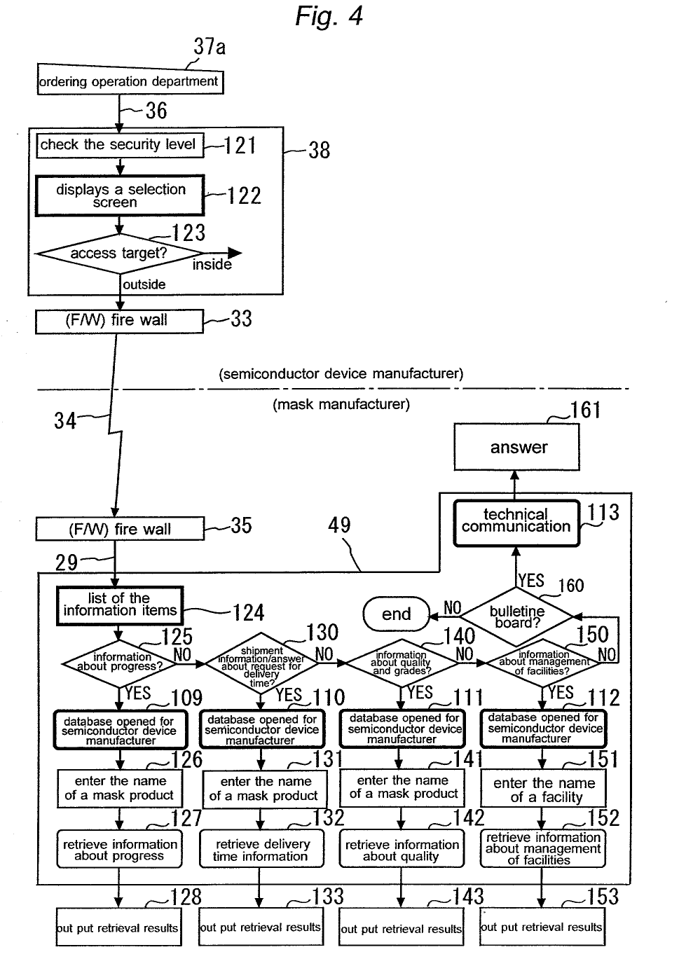

FIG. 4 is a flowchart showing the process described previously. When a staff member responsible for ordering in the semiconductor device manufacturer 1 accesses the information management server 38 from the terminal 37a by way of the LAN 36, the information management server 38 checks a security level (121). Subsequently, the information control server 38 displays a selection screen for targets of access (122). When a selected target of access is a mask manufacturer outside the semiconductor device manufacturer 1 (123), a link list pertaining to the information managed by the information management server 49 of the mask manufacturer 2 is displayed. As mentioned previously, the displayed link list varies according to the security level assigned to a person who attempts to make access.

The information management server 49 of the mask manufacturer 1 displays five items; that is, “information about progress,” “shipment information and answers to a requested delivery time,” “information about quality and grades,” “information about management of facilities,” and a “bulletin board,” as link lists pertaining to information items on a screen of the terminal 37a of a responsible business representative of the semiconductor device manufacturer 1 (124). When “information about progress” has been selected (125), the database server 51 of the information management server 49 selects a database opened to the semiconductor device manufacturer 1 (109). A retrieval screen for entering the name of a mask product is displayed (126), information about progress in production of masks corresponding to the entered product name is retrieved (127). Retrieval results are output on the screen in the form of a list (128). The information can be downloaded or output to a printer, as required. Even when any one of “shipment information/answer about request for delivery time” (130), “information about quality and grades” (140), and “information about management of facilities” (150) has been selected, the similar processing is performed (110, 131, 132, 111, 141, 142, 112, 151, and 152). Corresponding information is output to the screen (133, 143, and 153). When a “bulletin board” has been selected (125), engineering communication information is displayed on the bulletin board (113), whereby required information can be acquired through retrieval (161). For instance, information that no orders can be accepted since facilities installed along the production line are temporarily deactivated for maintenance purpose is posted on the bulletin board.

As has been described, in the ordering system according to the first embodiment, the semiconductor device manufacturer 1 manages ordering information by means of the information management server 38 controlled by the semiconductor device manufacturer 1. Hence, ordering information or other information items can be transmitted in the form of a free format without being limited to an order format prepared in accordance with the convenience of the mask manufacturer 2. Further, progress in production of masks is accumulated in and managed by the information management server 49 of the mask manufacturer 2 in substantially real time. Hence, the status of progress in production can be readily grasped without involvement of manpower, by means of accessing the information management server 49. In contrast with a case where information is exchanged by way of a business representative, the mask manufacturer 1 can readily acquire, at an early point in time, specification information prepared by a designer of the semiconductor device manufacturer 1. A mask can be produced efficiently on the basis of accurate information. A person who attempts to acquire information items is subjected to a predetermined security check. Hence, confidentiality of information is ensured. A data server retrieves data over a database, and a WEB server performs security check and controls accesses. Accordingly, load is distributed. Even when a plurality of accesses are made simultaneously to the information management server or a large volume of information is retrieved, processing can be performed immediately.

Second Embodiment

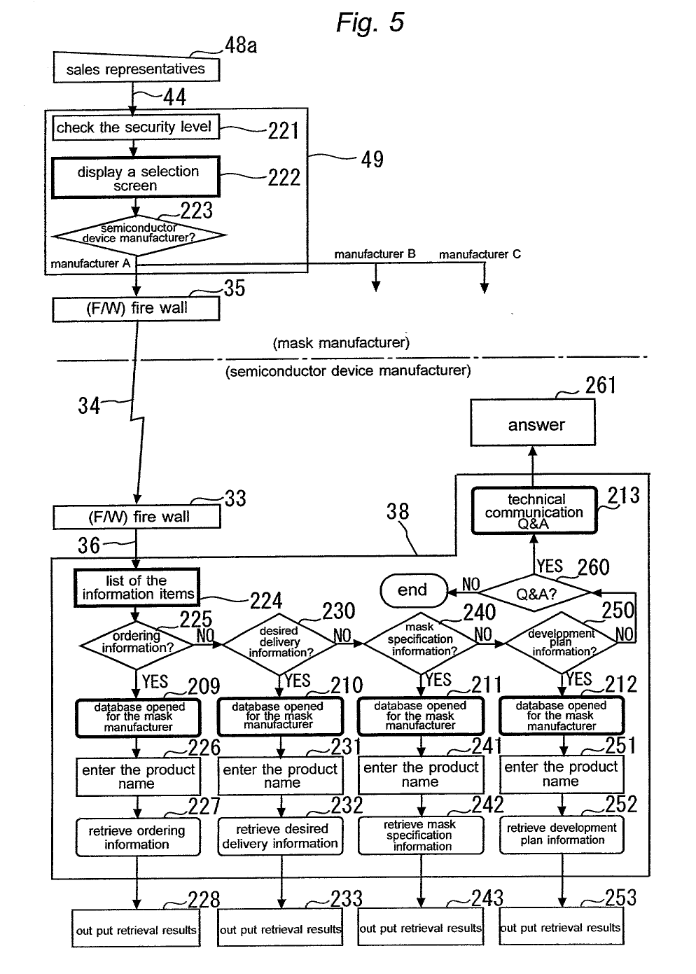

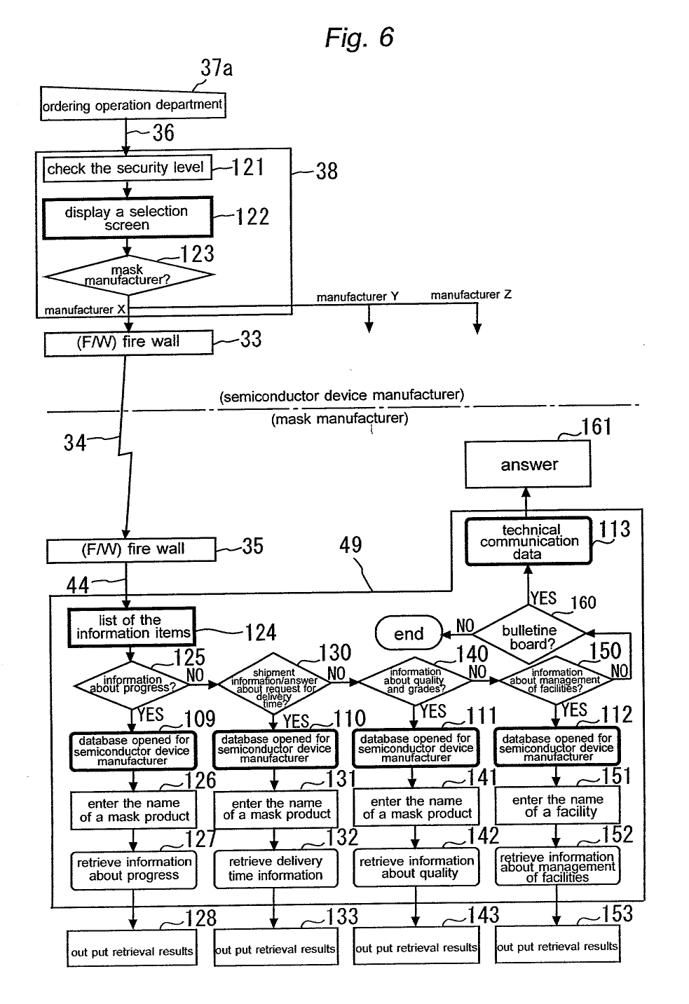

FIG. 5 and FIG. 6 show an embodiment suitable for a scenario in which a plurality of semiconductor device manufacturers conduct business with a plurality of mask manufacturers rather than a single semiconductor device manufacture conducting business with a single mask manufacturer. In such a case, there is a necessity of enhancing limitation on access to an information management server. If a person in charge can access an information management server of a company differing from a company for which the person is responsible, inconvenience may arise. An ordering system according to the second embodiment is identical in physical configuration with that described in connection with the first embodiment. However, the systems differ from each other in terms of processing to be performed by programs installed in computers constituting the systems, as follows.

In the system according to the second embodiment, the terminal 37a of the ordering operation department of the semiconductor device manufacturer 1 prepares an order statement for each mask manufacturer. Various types of information items are registered in various forms so as to be differentiated from each other according to mask manufacturer. Similarly, the production control server 45 of the mask manufacturer prepares production control information for each semiconductor device manufacturer. Further, the quality control server 47 prepares quality control information for each semiconductor device manufacturer. Various kinds of information items are registered in various formats in the database 53 so as to be differentiated from each other according to semiconductor device manufacturer.

As shown in FIG. 5, in the ordering system according to the second embodiment, after the information management sever 49 of the mask manufacturer has checked a security level (221), a business partner selection screen is displayed (222). After the thus-selected business partner is determined (223), a link list-which has been arranged with the security level and the selected semiconductor device manufacturer-are displayed. As shown in FIG. 6, after having checked a security level (121), the information management server 38 of the semiconductor device manufacturer displays a business partner selection screen (122) and determines the thus-selected business partner (123). Then, the information management server 38 displays a link list which has been arranged with a security level and the thus-selected mask manufacturer.

As has been described above, in addition to the same advantage as that yielded in the first embodiment, the ordering system according to the second embodiment yields an advantage of ability to ensure confidentiality and prevent undesired disclosure of information even when a company has business relationships with a plurality of corporations.

Needless to say, the ordering system according to the present invention is not limited to an order for masks and can be applied to an order for any type of product. The ordering system according to the present invention can be applied to an order for a service as well as to an order for a product. For instance, the system can be applied to a request for inspecting a mask.

The features and advantages of the present invention may be summarized as follows.

Under the ordering method according to the present invention and in the ordering system according to the same, when an order for a product or service is placed by way of a network, a client does not place an order by accessing an order acceptance server prepared by a product provider, which has hitherto been the case. Instead, a client makes order information open to the product provider on an information management server controlled by the client, and a product provider accesses the server, to thereby acquire the order information. Thus, ordering procedures are performed. As a result, a client is released from an order format prepared for the convenience of a product provider, which has hitherto been employed. The client can transmit all types of information desired to be transmitted to product providers, as well as order information, in a free format such as an image or voice. Further, even when sudden changes have arisen in specifications, the only requirement imposed on a client is to update information stored in the server and to inform a responsible person of the changes. There can be obviated a necessity of making arrangements with a responsible person by reference to unamended specifications and amended specifications for ascertaining the changes, which has hitherto been performed.

Further, a product provider also discloses all kinds of information, including information about progress in business, on an information management server controlled by the product provider, in order to make communication with a client robust. As a result, a client and a product provider can transmit information to each other, thereby preventing occurrence of a failure in business transaction, which would otherwise be caused by tenuous communication. Particularly, the client can place orders according to a plan after having ascertained the status of the product provider. Hence, the client can diminish a formidable order having a very tight deadline. So long as the product provider can collect information about progress in production at a production line in real time and disclose the information on the information management server, the product provider can transmit the latest information about progress to the client.

The confidentiality of information can be ensured by means of identifying a person who attempts to acquire order information and limiting acquisition of information about a delivery time on the basis of the identification result, or identifying a person who attempts to acquire information about a delivery time in the same manner and limiting acquisition of the information.

If the information management server is not limited to a single server computer and is constituted of two computers, such as a database server and a WEB server, load is distributed. As a result, processing can be effected immediately in the event that a plurality of accesses are made simultaneously or a large quantity of information is retrieved.

If the ordering method and system according to the present invention are employed for business between a semiconductor device manufacturer and a mask manufacturer, complicated engineering information, such as information about mask specifications, can be transmitted accurately and immediately. Business transaction employing the method and system yields an advantage greater than that yielded as a result of business transaction of ready-made products.

It is further understood that the foregoing description is a preferred embodiment of the disclosed method and system, and that various changes and modifications may be made in the invention without departing from the spirit and scope thereof.

The entire disclosure of a Japanese Patent Application No.2001-090659, filed on Mar. 27,2001 including specification, claims, drawings and summary, on which the Convention priority of the present application is based, are incorporated herein by reference in its entirety.

What is claimed is:

1. An ordering method of placing an order for a product or service by way of a network, the method comprising the steps of:
storing order information including an order for a product or service into an information management server of a client which manages an order for a product or service;
rendering the stored order information available by way of the network; and
placing an order for a product or service by causing a product or service provider to acquire the order information.

2. The ordering method according to claim 1, wherein delivery time information indicating a delivery time of a product or a deadline for service is stored in an information management server of the provider which manages a delivery time;
rendering the stored deliver time information available by way of the network; and
enabling the client to ascertain the delivery time of a product or a deadline for a service.

3. The ordering method according to claim 2, wherein the deliver time information is prepared and made available in real in accordance with progress in operation performed by the provider.

4. The ordering method according to claim 1, wherein a person who attempts to acquire the order information is identified, and acquisition of the order information is limited on the basis of a result of identification.

5. The ordering method according to claim 2, wherein a person who attempts to acquire the delivery time information is identified, and acquisition of the delivery time information is limited on the basis of a result of identification.

6. The ordering method according to claim 1, wherein the information management server of the client is constituted of a database server and a WEB server, thereby distributing load imposed on the information management server.

7. The ordering method according to claim 2, wherein the information management server of the provider is constituted of a database server and a WEB server, thereby distributing load imposed on the information management server.

8. The ordering method according to claim 1, wherein the client is a semiconductor product manufacturer, and the product or service provider is a mask manufacturer.

9. The ordering method according to claim 8, wherein the order information includes specifications of a mask.

10. An ordering system utilizing a network, comprising:
an information management server of a client having a function of accumulating and managing order information including an order for a product or service and a function of rendering the order information available by way of the network; and
a computer of a product or service provider which is connected to the information management server by way of the network and which receives an order by means of acquiring the order information from the client's information management server.

11. The ordering system according to claim 10, wherein the provider's computer serves as an information management server which has a function of accumulating and managing delivery time information indicating a delivery time of a product or a deadline for a service and a function of rendering the delivery time information available by way of the network.

12. The ordering system according to claim 11, wherein the delivery time information is prepared in real time in accordance with progress in operation performed by the provider.

13. The ordering system according to claim 10, wherein the computer of the provider has a function of identifying a person who attempts to acquire order information and a function of limiting acquisition of the order information on the basis of a result of identification.

14. The ordering system according to claim 11, wherein the client's information management server has a function of identifying a person who attempts to ascertain delivery time information and a function of limiting ascertainment of the delivery time information on the basis of a result of identification.

15. The ordering system according to claim 10, wherein the client's information management server is constituted of a database server and a WEB server, thereby distributing load imposed on the information management server.

16. The ordering system according to claim 11, wherein the provider's information management server is constituted of a database server and a WEB server, thereby distributing load imposed on the information management server.

17. The ordering system according to claim 10, wherein the client is a semiconductor product manufacturer, and the product or service provider is a mask manufacturer.

18. The ordering system according to claim 17, wherein the order information includes specifications of a mask.
